(19) United States
(12) Patent Application Publication
(10) Pub. No.: US 2022/0095138 A1
(43) Pub. Date: Mar. 24, 2022

(54) MONITORING DEVICE, COMMUNICATION SYSTEM, AND MONITORING METHOD

(71) Applicant: NEC Corporation, Tokyo (JP)

(72) Inventor: Hajime Iwata, Tokyo (JP)

(73) Assignee: NEC Corporation, Tokyo (JP)

(21) Appl. No.: 17/473,110

(22) Filed: Sep. 13, 2021

(30) Foreign Application Priority Data
Sep. 18, 2020 (JP) 2020-157497

(51) Int. Cl. H04W 24/08

(52) U.S. Cl. CPC H04W 24/08

(57) ABSTRACT

A monitoring device according to the present disclosure is capable of communicating with a plurality of transmission devices. The monitoring device includes an acquiring unit that acquires traffic information of a plurality of transmission lines connecting between the plurality of transmission devices and topology information of the transmission lines. The monitoring device further includes a predicting unit that predicts traffic on each of the transmission lines based on the traffic information and the topology information.

### INCORPORATION BY REFERENCE

This application is based upon and claims the benefit of priority from Japanese patent application No. 2020-157497, filed on Sep. 18, 2020, the disclosure of which is incorporated herein in its entirety by reference.

### TECHNICAL FIELD

The present disclosure relates to monitoring devices, communication systems, monitoring methods, and monitoring programs.

### BACKGROUND ART

In recent years, communication services, such as searches and video viewing, via PCs, smartphones, or the like have spread worldwide, causing increased communication traffic. This necessitates not only the mere investment in the equipment but means for efficiently distributing data flowing over communication networks, in order to continuously maintain and improve the quality of communication henceforth.

To distribute data efficiently over communication networks and to use network equipment effectively, it is important to predict traffic with higher accuracy. International Patent Publication No. WO2012/173036 discloses a technique for predicting flowing traffic based on traffic information accumulated by a transmitter-receiver in a wireless communication network. Network equipment can be used effectively when transmission power is controlled based on the predicted traffic.

### SUMMARY

According to the technique disclosed in International Patent Publication No. WO2012/173036, a transmission device predicts traffic and changes the multi-value level of the modulation scheme and the transmission power in accordance with the predicted traffic. However, when the modulation scheme and the transmission power are to be determined based on the traffic predicted by one transmission device, even if the control of the modulation scheme and so on with respect to the transmission line for this transmission device is appropriate, there still exists a problem that this control may not be necessarily appropriate for another transmission line within the same communication system.

The present disclosure has been made to address such a problem and is an object to providing a monitoring device, a communication system, a monitoring method, and a monitoring program that predict traffic appropriate for an entire communication system and control each modulation scheme and each transmission power.

A monitoring device according to the present disclosure is capable of communicating with a plurality of transmission devices and includes an acquiring unit and a predicting unit. The acquiring unit is configured to acquire traffic information of a plurality of transmission lines connecting between the plurality of transmission devices and topology information of the transmission lines. The predicting unit is configured to predict traffic on each of the transmission lines based on the traffic information and the topology information.

A communication system according to the present disclosure includes a plurality of transmission devices and a monitoring device connected to and capable of communicating with the plurality of transmission devices. The monitoring device includes an acquiring unit and a predicting unit. The acquiring unit is configured to acquire traffic information of a plurality of transmission lines connecting between the plurality of transmission devices and topology information of the transmission lines. The predicting unit is configured to predict traffic on each of the transmission lines based on the traffic information and the topology information. The transmission devices each acquire predicted traffic information indicating the traffic predicted by the monitoring device.

A monitoring method according to the present disclosure includes a step of acquiring traffic information of a plurality of transmission lines connecting between a plurality of transmission devices, a step of acquiring topology information of the transmission lines, and a step of predicting traffic on each of the transmission lines based on the traffic information and the topology information.

A monitoring program according to the present disclosure causes an information processing device to execute a process of acquiring traffic information of a plurality of transmission lines connecting between a plurality of transmission devices, a process of acquiring topology information of the transmission lines, and a process of predicting traffic on each of the transmission lines based on the traffic information and the topology information.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram of a communication system according to a first example embodiment of the present disclosure;

FIG. 2 is a block diagram of a communication system according to a second example embodiment of the present disclosure;

FIG. 3 is a block diagram of a network monitoring device according to the second example embodiment of the present disclosure;

FIG. 4 illustrates an example of a topology DB according to the second example embodiment of the present disclosure;

FIG. 5 illustrates an example of a traffic DB according to the second example embodiment of the present disclosure;

FIG. 6 illustrates an example of a quality DB according to the second example embodiment of the present disclosure;

FIG. 7 is a block diagram of a transmission device according to the second example embodiment of the present disclosure;

FIG. 8 is a sequence diagram of traffic prediction according to the second example embodiment of the present disclosure;

FIG. 9 is a flowchart of traffic prediction according to the second example embodiment of the present disclosure;

FIG. 10 is another flowchart of traffic prediction according to the second example embodiment of the present disclosure;

FIG. 11 illustrates an example of how the control on the modulation scheme and the power consumption is determined according to the second example embodiment of the present disclosure; and

FIG. 12 is a sequence diagram of the control on the modulation scheme and the power consumption according to the second example embodiment of the present disclosure.

### EMBODIMENTS

Hereinafter, some example embodiments will be described with reference to the drawings. It is to be noted that the drawings are schematic, and thus the technical scope of the example embodiments should never be interpreted narrowly based on the drawings. In the drawings, identical elements are given identical reference characters, and repetitive descriptions thereof will be omitted.

The following example embodiments are described via a plurality of sections or example embodiments, if necessary. However, it is not that these sections or example embodiments are unrelated to each other, unless clearly and specifically indicated otherwise, and one section or example embodiment may be in relation to a modified example, an application example, a detailed description, a supplementary description, or the like of a part or the whole of another section or example embodiment. When the number or the like of elements (including the number of pieces, any numerical value, quantity/amount, range, etc.) is indicated with regard to the following example embodiments, that number is not limited to the specific number indicated and may be greater than, equal to, or smaller than the specific number indicated, unless clearly and specifically indicated otherwise and unless theoretically that number is limited clearly to the specific number indicated.

Moreover, the constituent elements (including the operation steps, etc.) according to the following example embodiments are not necessarily essential, unless clearly and specifically indicated otherwise and unless theoretically such constituent elements are clearly considered essential. Similarly, when the shapes, the positional relationships, and so on of the constituent elements according to the following example embodiments are described, any shapes and so on that are substantially close or similar to the described shapes and so on are also encompassed, unless clearly and specifically indicated otherwise and unless theoretically these shapes and so on are clearly not close or similar to the described shapes and so on. This applies in a similar manner to the number or the like (including the number of pieces, any numerical value, quantity/amount, range, etc.) described above.

### First Example Embodiment

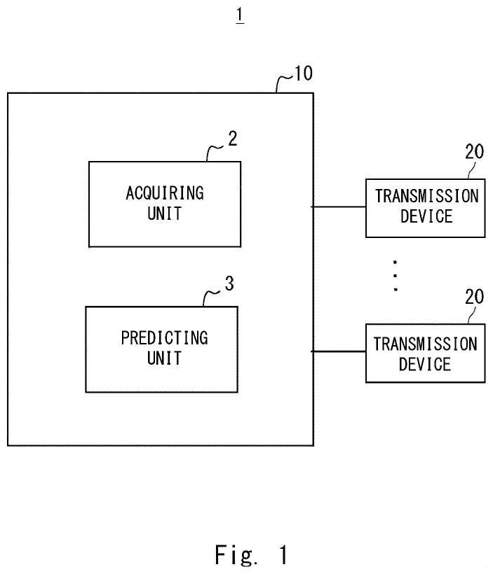

With reference to FIG. 1, a configuration of a communication system 1 according to the present example embodiment will be described. FIG. 1 illustrates a configuration of the communication system 1 according to the present example embodiment. The communication system 1 according to the present example embodiment includes a monitoring device 10 and a plurality of transmission devices 20.

The monitoring device 10 according to the present example embodiment includes a plurality of transmission lines connected with and to communicate with the respective transmission devices 20. The monitoring device 10 further includes an acquiring unit 2 and a predicting unit 3. The transmission lines between the monitoring device 10 and the respective transmission devices 20, and the transmission lines between the plurality of transmission devices 20, may each be a wired transmission line formed by a cable or a wireless transmission line.

The acquiring unit 2 acquires traffic information on communication traffic of the transmission lines connecting between the plurality of transmission devices 20. The acquiring unit 2 further acquires topology information on a network topology formed by the transmission devices 20 and the transmission lines. The predicting unit 3 predicts traffic on each transmission line based on the traffic information and the topology information acquired by the acquiring unit 2. The information on the predicted traffic will be referred to below as predicted traffic information.

With the monitoring device 10 according to the present example embodiment, traffic appropriate for the entire communication system 1 is predicted, and the modulation scheme and the transmission power can be controlled accordingly.

### Second Example Embodiment

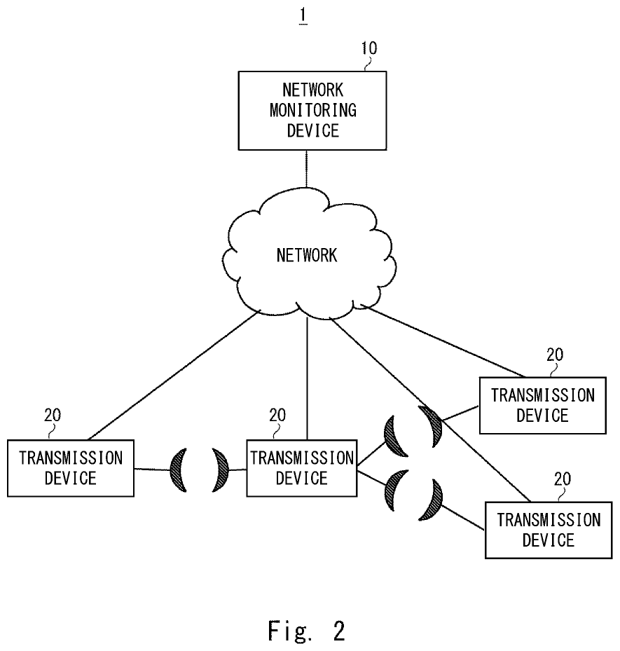

With reference to FIG. 2, a configuration of a communication system 1 according to the present example embodiment will be described. FIG. 2 illustrates a configuration of the communication system 1 according to the present example embodiment.

In the communication system 1, a monitoring device 10 and a plurality of transmission devices 20 can communicate with each other. Moreover, the transmission devices 20 can communicate with each other. A network between the monitoring device 10 and the plurality of transmission devices 20 is typically a data communication network (DCN). The DCN may be a wireless network or a wired network. According to the present example embodiment, the DCN is a wireless network. Communication between the transmission devices 20 may be wireless communication or wired communication. According to the present example embodiment, the transmission devices 20 communicate via wireless communication.

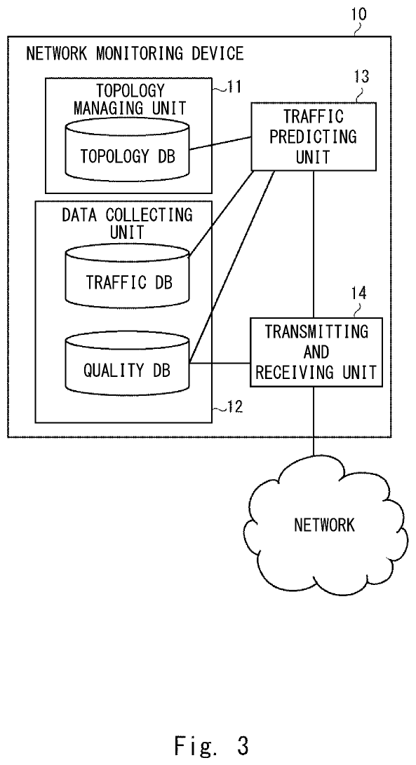

FIG. 3 illustrates a configuration of the monitoring device 10. The monitoring device 10 includes a topology managing unit 11, a data collecting unit 12, a traffic predicting unit 13, and a transmitting and receiving unit 14. The monitoring device 10 is capable of communicating with the transmission devices 20. The monitoring device 10 is typically a network monitoring device, but this is not a limiting example. The monitoring device 10 is preferably capable of monitoring the communication status, such as the network topology or traffic. Moreover, the monitoring device 10 is preferably capable of exchanging traffic information with the transmission devices 20. The monitoring device 10 may be capable of communicating with another monitoring device 10.

The monitoring device 10 may be, for example, a server or a personal computer (PC) or may be a portable device, such as a tablet terminal. The monitoring device 10 may further include a storage unit (not illustrated) that stores a topology DB, a traffic DB, and a quality DB, which will be described later. The storage unit is a nonvolatile storage device, and an information medium, such as a flash memory, a hard-disk drive (HDD), a solid-state drive (SSD), or an optical disc drive, can be used as the storage unit, for example.

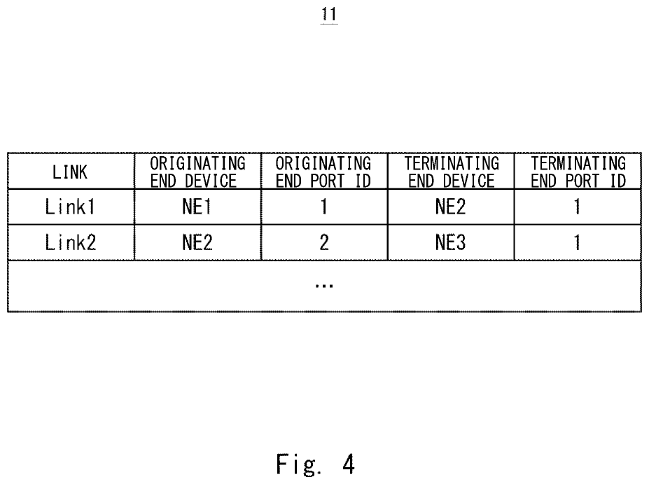

The topology managing unit 11 includes a topology DB. The topology DB stores topology information regarding topology of the transmission devices 20 connected to the monitoring device 10. FIG. 4 illustrates an example of data in the topology DB according to the present example embodiment. As shown, the topology DB stores connection relations (originating end device/port to terminating end device/port) of wireless links connecting between the transmission ports of the transmission devices 20. The NE in figs means the transmission device. NE1, NE2, NE3, . . . indicate identification information for the transmission devices. The link in the topology DB is identified by the device ID and the port ID of the originating end transmission device, and the device ID and the port ID of the terminating end transmission device.

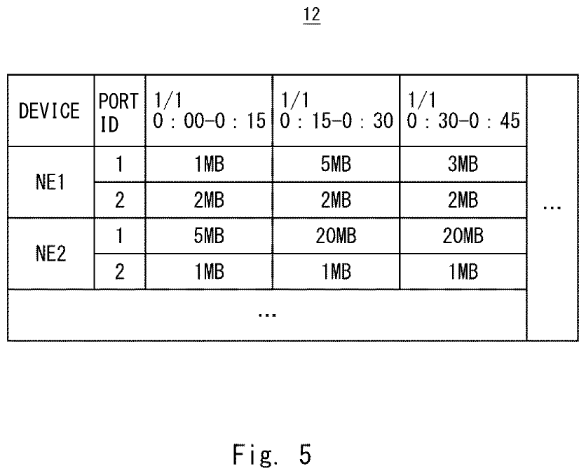

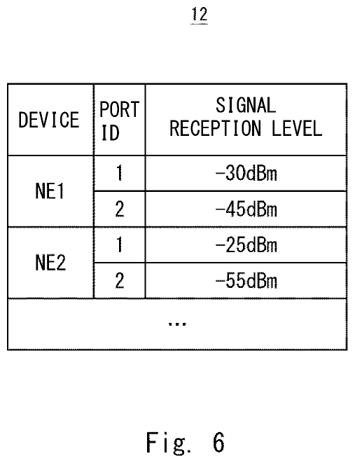

The data collecting unit 12 includes a traffic DB and a quality DB. The data collecting unit 12 acquires, from each transmission device 20, traffic transmission performance information indicating the amount of data transmitted in a predefined period. The data collecting unit 12 stores, into the traffic DB, the acquired traffic transmission performance information along with port ID information of a traffic transmitting unit 24 of the transmission device 20 that has transmitted the traffic transmission performance information. FIG. 5 illustrates an example of data in the traffic DB according to the present example embodiment. As shown, the traffic DB stores a history of the transmission traffic amount (in each period of time) of each transmission port of each transmission device 20. The data collecting unit 12 acquires, from each transmission device 20, signal reception level information indicating the quality of transmission. FIG. 6 illustrates an example of data in the quality DB according to the present example embodiment. As shown, the quality DB stores signal reception level information of each transmission port of each transmission device 20.

The traffic predicting unit 13 predicts the traffic of the traffic transmitting unit 24 of each transmission device 20 based on the data in the traffic DB and the data in the topology DB. The traffic is predicted in terms of the number of bytes to be transmitted in fifteen minutes henceforth, for example, but this is not a limiting example. Preferably, the amount of data transmitted in a predefined period is predicted. In one method of predicting the traffic, a plurality of rules that coexist in each piece of data may be extracted in accordance with the data classification, such as the past traffic demand data or the topology information, for example, and the prediction may be made accordingly (heterogeneous mixture learning technique). The method of predicting the traffic is not limited to the method that involves the heterogeneous mixture learning technique, and various other predicting methods can be used. The predicted traffic information along with the port ID information of the traffic transmitting unit 24 of the transmission device 20 is transmitted to each transmission device 20 via the transmitting and receiving unit 14 of the monitoring device 10.

The transmitting and receiving unit 14 transmits, to each transmission device 20, predicted traffic information of each transmission device 20 predicted by the traffic predicting unit 13.

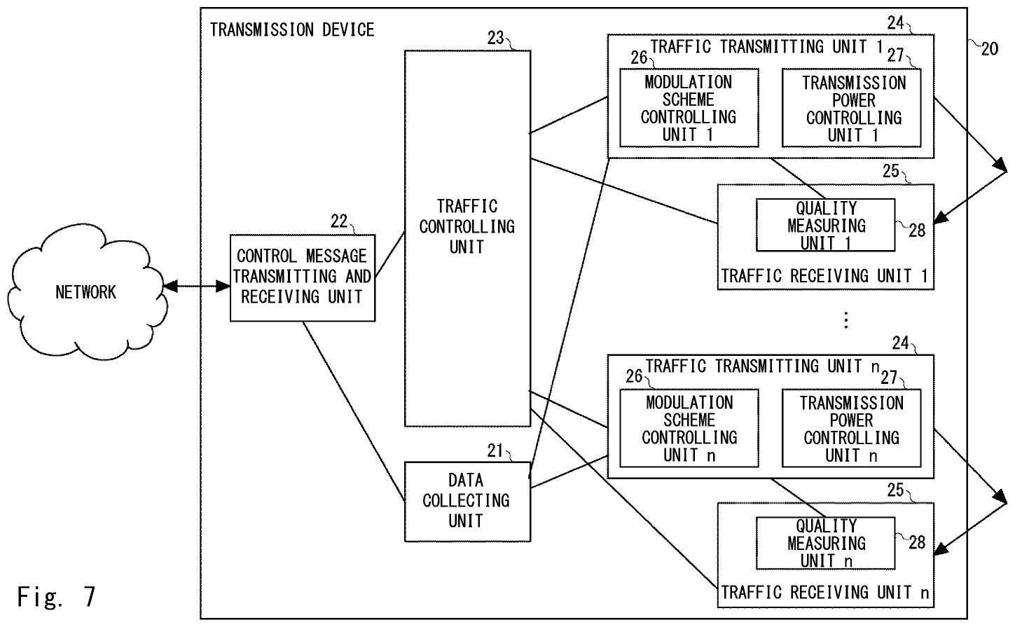

FIG. 7 illustrates a configuration of a transmission device 20. The transmission device 20 includes a data collecting unit 21, a control message transmitting and receiving unit 22, a traffic controlling unit 23, traffic transmitting units 24, and traffic receiving units 25. The transmission device 20 is capable of communicating with the monitoring device 10. Moreover, the transmission device 20 is capable of communicating with another transmission device 20.

The transmission device 20 is preferably capable of transmitting and receiving data (traffic). The transmission device 20 is preferably capable of exchanging traffic information on the traffic with the monitoring device 10. Moreover, the transmission device 20 is capable of communicating with another transmission device 20. The transmission device 20 is preferably capable of exchanging traffic with another transmission device 20.

The data collecting unit 21 monitors the traffic transmitted by the traffic transmitting units 24. The data collecting unit 21 transmits traffic transmission performance information periodically to the control message transmitting and receiving unit 22. The traffic transmission performance information indicates, for example but not limited to, the number of bytes transmitted in the past fifteen minutes, but this is not a limiting example. The traffic transmission performance information is information regarding the amount of data transmitted in a predefined period, for example. The data collecting unit 21 may transmit the port ID information of the traffic transmitting unit 24 to the control message transmitting and receiving unit 22.

The control message transmitting and receiving unit 22 transmits and receives information (control message) to and from the monitoring device 10. The control message transmitting and receiving unit 22 transmits, to the monitoring device 10, the traffic transmission performance information and the port ID information of the traffic transmitting unit 24 acquired from the data collecting unit 21. Moreover, the control message transmitting and receiving unit 22 acquires signal reception level information, described later, from the traffic receiving units 25 and transmits the acquired signal reception level information to the monitoring device 10.

The control message transmitting and receiving unit 22 acquires predicted traffic information from the monitoring device 10. The control message transmitting and receiving unit 22 transmits the acquired predicted traffic information to the traffic controlling unit 23.

The traffic controlling unit 23 determines the modulation scheme and the transmission power based on the predicted traffic information acquired from the monitoring device 10 via the control message transmitting and receiving unit 22 and the signal reception level information of the traffic receiving units 25. The traffic controlling unit 23 transmits information indicating the determined modulation scheme and transmission power to modulation scheme controlling units 26 and transmission power controlling units 27 of the traffic transmitting units 24. The method of determining the modulation scheme and the transmission power will be described later in detail.

The traffic transmitting unit 24 includes the modulation scheme controlling unit 26 and the transmission power controlling unit 27. The traffic transmitting unit 24 acquires the modulation scheme and the transmission power determined by the traffic controlling unit 23. The modulation scheme controlling unit 26 and the transmission power controlling unit 27 control the traffic transmitting unit 24 so that the traffic transmitting unit 24 transmits traffic to another transmission device 20 in accordance with the acquired information indicating the modulation scheme and the transmission power.

The traffic receiving unit 25 includes a quality measuring unit 28. The traffic receiving unit 25 transmits signal reception level information to the control message transmitting and receiving unit 22.

The quality measuring unit 28 periodically measures the signal reception level of the wireless transmission line between another transmission device 20. The measured signal reception level information is transmitted to another transmission device 20 that is capable of communicating with the transmission device 20 via its own traffic transmitting unit 24. The signal reception level information is transmitted typically by use of a control signal of the transmission line, but this is not a limiting example. The signal reception level information is transmitted to another transmission device 20 capable of communicating with the transmission device 20 with each other. The transmission device 20 transmits the acquired signal reception level information to the traffic controlling unit 23 and the monitoring device 10. The signal reception level information is referred to when the traffic is predicted or when the modulation scheme and the transmission power are determined. The transmission device 20 may transmit the acquired signal reception level information to the monitoring device 10 via the data collecting unit 21.

### Example of Operation of Communication System 1 According to Present Example Embodiment.

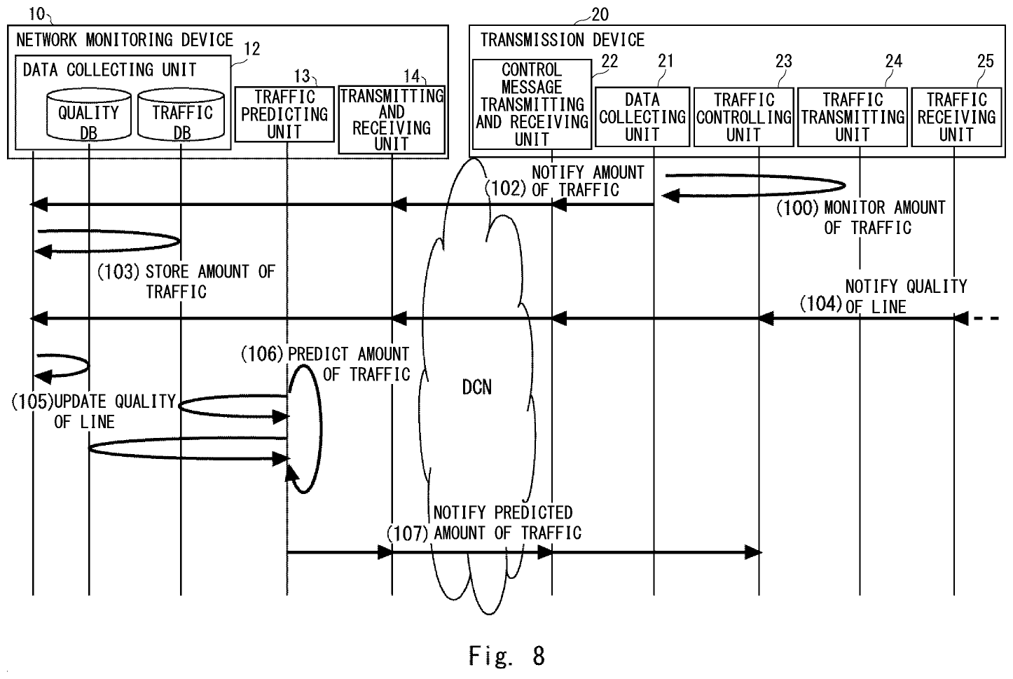

First, with reference to FIG. 8, a flow of how the monitoring device 10 predicts traffic will be described. FIG. 8 is a sequence diagram of traffic prediction according to the present example embodiment.

The data collecting unit 21 of the transmission device 20 monitors the amount of traffic of the traffic transmitting unit 24 (step 100) and periodically transmits traffic transmission performance information (amount of traffic acquired by monitoring) along with the port ID information of the traffic transmitting unit 24 to the monitoring device 10 via the control message transmitting and receiving unit 22 (step 102).

The monitoring device 10 stores, into the traffic DB, the traffic transmission performance information (amount of traffic) received from the transmission device 20 along with the port ID information of the transmission device 20 (step 103).

The monitoring device 10 receives, from the transmission device 20, signal reception level information (quality of line) measured by the traffic receiving unit 25 of the transmission device 20 (step 104). Based on the received signal reception level information, the monitoring device 10 updates, in the quality DB, the signal reception level information (quality of line) and the port ID information of the transmission device 20 that has transmitted these pieces of information (step 105).

The traffic predicting unit 13 of the monitoring device 10 predicts the traffic (amount of traffic) of the traffic transmitting unit 24 of each transmission device 20 based on the data in the traffic DB and the data in the topology DB (step 106). Further, the traffic predicting unit 13 predicts the traffic based on the data in the quality DB. The monitoring device 10 notifies each transmission device 20 of the predicted traffic information (amount of traffic) (step 107).

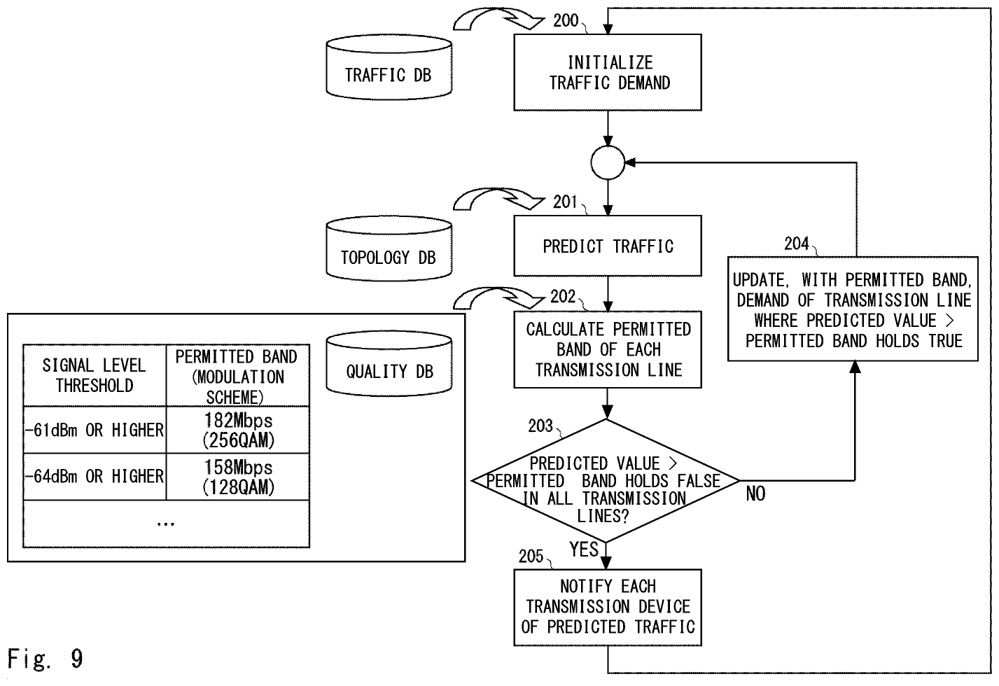

Now, with reference to FIG. 9, how the monitoring device 10 predicts the traffic will be described in detail. FIG. 9 is a flowchart of traffic prediction according to the present example embodiment.

First, traffic demand information in the traffic DB included in the data collecting unit 12 of the monitoring device 10 is initialized (step 200). The traffic predicting unit 13 of the monitoring device 10 predicts the traffic of the traffic transmitting unit 24 of each transmission device 20 based on the data in the traffic DB and the data in the topology DB (step 201).

The traffic predicting unit 13 refers to the quality DB included in the data collecting unit 12 of the monitoring device 10 and calculates a permitted band of each transmission line based on the signal reception level information of the transmission devices 20 in the respective transmission lines (step 202). As shown, signal level thresholds are associated to permitted bands (modulation schemes). The traffic predicting unit 13 compares the signal reception level of the transmission line to the signal level thresholds, decides a permitted band corresponding to the signal reception level based on the result of comparison.

The traffic predicting unit 13 checks whether there is a transmission line for which the calculated predicted value of the traffic exceeds the permitted band (step 203). If there is a transmission line for which the calculated predicted value of the traffic exceeds the permitted band (NO at step 203), the traffic predicting unit 13 sets the demand for the traffic in this transmission line equal to the permitted band (it is assumed that traffic over the permitted band is discarded) (step 204) and predicts the traffic on the entire network again (step 201).

If there is no transmission line for which the calculated predicted value of the traffic exceeds the permitted band (YES at step 203), the monitoring device 10 transmits the predicted traffic information to each transmission device 20 (step 205).

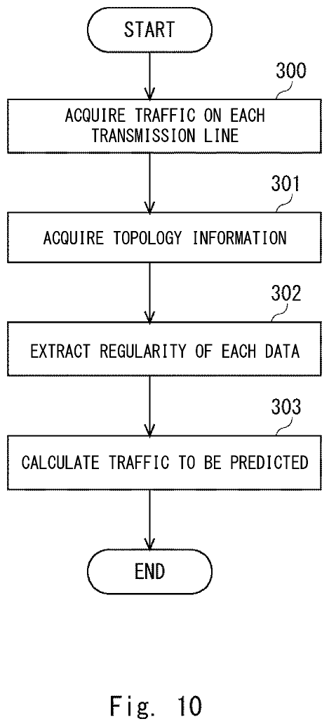

Now, with reference to FIG. 10, the prediction of the traffic at step 201 above will be described in further detail. The traffic predicting unit 13 acquires the traffic on each transmission line (step 300). The traffic predicting unit 13 further acquires topology information (step 301). Based on the acquired traffic information and topology information, the traffic predicting unit 13 extracts the regularity of each data (step 302) and calculates the traffic to be predicted (step 303).

As described above, the traffic is predicted based not only on the traffic information of a single transmission device 20 but also on the traffic information and so on of the entire network, and this can improve the accuracy in predicting the traffic. The improved accuracy in predicting the traffic makes it possible to reduce the transmission power while keeping the capacity and quantity of line optimal for each the traffic demand.

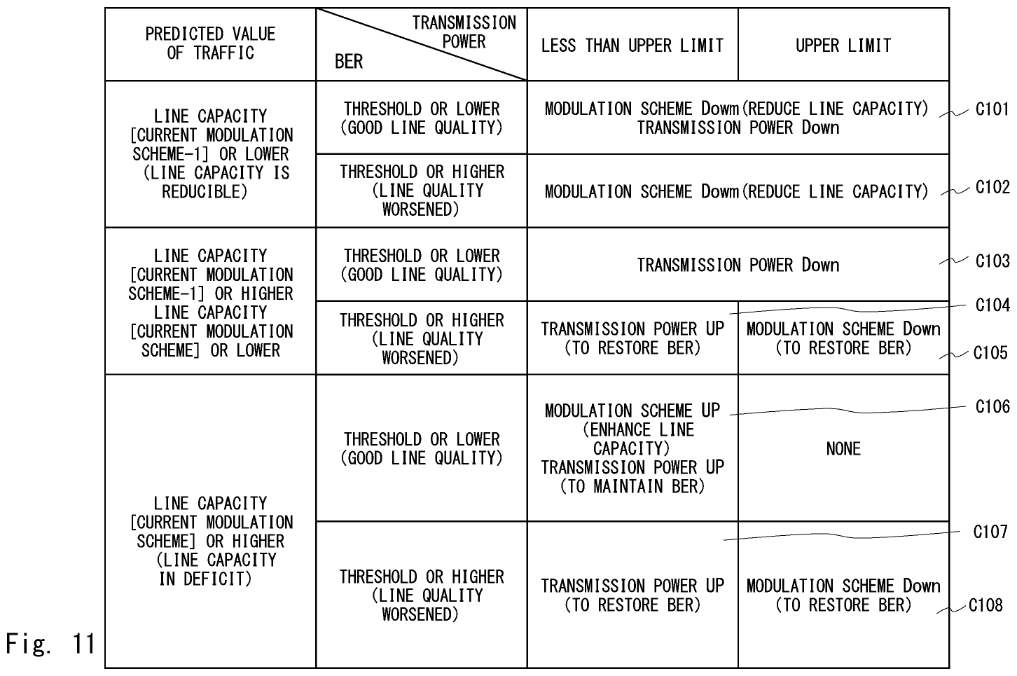

Now, with reference to FIG. 11, an overview of how the monitoring device 10 makes a determination on the control of the modulation scheme and the power consumption of each transmission device 20 will be described. FIG. 11 illustrates an example of how the control on the modulation scheme and the power consumption is determined according to the present example embodiment.

The line capacity is dependent on the modulation scheme. For example, in a case where the multi-value quadrature amplitude modulation scheme is used, the transmission capacity differs depending on the multi-value level in the modulation scheme. In FIG. 11, CURRENT MODULATION SCHEME−1 corresponds to a modulation scheme where the multi-value level has been lowered by one level from that of the current modulation scheme. Meanwhile, MODULATION SCHEME DOWN and MODULATION SCHEME UP mean, respectively, to lower and to raise the multi-value level of the modulation scheme. TRANSMISSION POWER DOWN and TRANSMISSION POWER UP mean, respectively, to lower and to raise the transmission power by a predetermined amount. In the example of the modulation scheme described above, the multi-value quadrature amplitude modulation scheme is used. The present example embodiment, however, is not limited to this example, and various other modulation schemes may be used.

The traffic controlling unit 23 calculates a line capacity based on the modulation scheme of the traffic transmitting unit 24 (CURRENT MODULATION SCHEME or CURRENT MODULATION SCHEME−1), and determines the modulation scheme and the transmission power for controlling the traffic transmitting unit 24 based on the predicted value of traffic and the line capacity. If the line capacity is determined to be in surplus (predicted value of traffic<line capacity [CURRENT MODULATION SCHEME−1]), the traffic controlling unit 23 of the transmission device 20 determines the modulation scheme and the transmission power so as to reduce the line capacity by switching the modulation scheme (MODULATION SCHEME DOWN) (C101 and C102 in FIG. 11). Conversely, if the line capacity is determined to be in deficit (predicted value of traffic>line capacity [CURRENT MODULATION SCHEME]), the traffic controlling unit 23 increases the line capacity by switching the modulation scheme (MODULATION SCHEME UP), and determines to raise the transmission power in order to avoid deterioration in the bit error rate (BER) (C106 in FIG. 11).

Moreover, the traffic controlling unit 23 compares the BER value estimated from the signal reception level and the modulation scheme against a threshold and determines to lower the transmission power if the BER is lower than the threshold (good line quality) (C101 and C103 in FIG. 11). Conversely, if the BER is higher than the threshold (line quality worsened), the traffic controlling unit 23, if possible, raises the transmission power (C104 and C107 in FIG. 11). If the transmission power has reached the upper limit already, the traffic controlling unit 23 determines to switch the modulation scheme (MODULATION SCHEME DOWN) in order to restore the BER (C105 and C108 in FIG. 11). If the line capacity is in surplus, the traffic controlling unit 23 refrains from determining to lower the transmission power (C102 in FIG. 11).

How the traffic controlling unit 23 makes a determination on the control of the modulation scheme and the power consumption of each transmission device 20 is not limited to the example illustrated in FIG. 11 and the foregoing descriptions, and the traffic controlling unit 23 may make such a determination through various other methods.

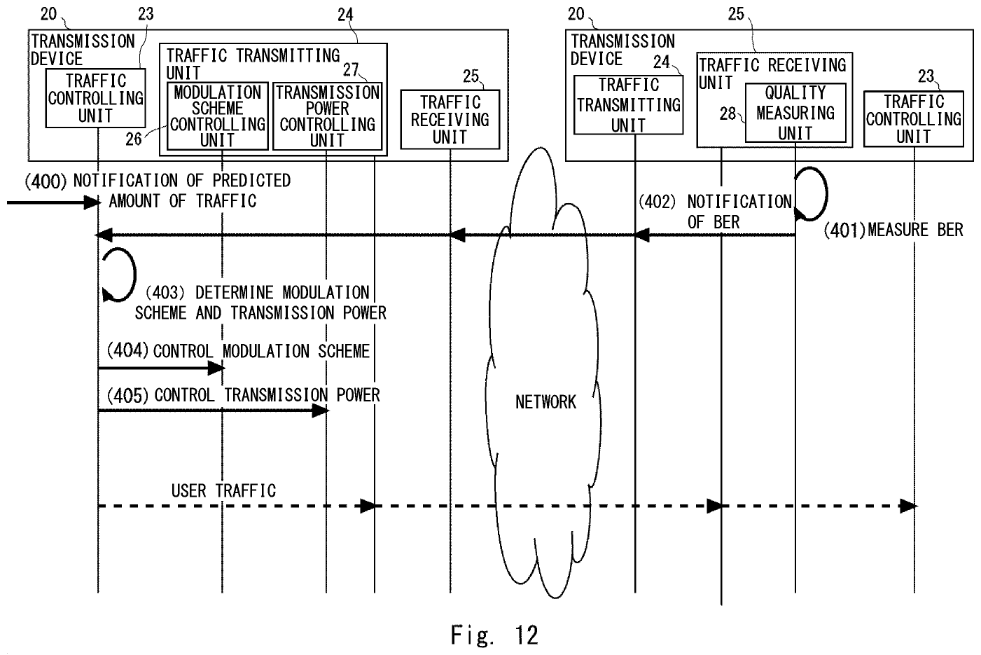

With reference to FIG. 12, a flow of how the transmission device 20 determines and controls the modulation scheme and the power consumption will be described. FIG. 12 is a sequence diagram of the control on the modulation scheme and the power consumption according to the present example embodiment.

The traffic controlling unit 23 of one transmission device 20 receives predicted traffic information (amount of traffic) from the monitoring device 10 (step 400). In addition, the quality measuring unit 28 of another transmission device 20 periodically measures the signal reception level (BER in an example of FIG. 12) of the transmission line (step 401). The measured signal reception level information (BER) is transmitted to the opposing transmission device 20 via the traffic transmitting unit (step 402). The signal reception level information (BER) may be transmitted by use of a control signal of the transmission line.

Upon the opposing transmission device 20 receiving the signal reception level information (BER), the signal reception level information (BER) is transmitted to the traffic controlling unit 23. The traffic controlling unit 23 refers to the received predicted traffic information (amount of traffic) and signal reception level information (BER) when making a determination on the modulation scheme and the transmission power (step 403). The signal reception level information may be transmitted to the monitoring device 10 as well. The modulation scheme controlling unit 26 and the transmission power controlling unit 27 transmit signals in accordance with the modulation scheme and the transmission power determined by the traffic controlling unit 23 (steps 404 and 405).

As described above, the modulation scheme and the transmission power are determined by the transmission device 20 autonomously based on the predicted traffic information and the signal reception level information (BER) between transmission devices 20. This allows the modulation scheme and the transmission power to be changed as needed in accordance with a change in the signal reception level.

As described above, the monitoring device 10 predicts the traffic based on the traffic information of the entire communication system 1 and the communication quality information and the topology information between the transmission devices 20 and transmits the result of the prediction to each transmission device 20. Thus, each transmission device 20 controls the modulation scheme and the transmission power based on the result of the prediction received from the monitoring device 10.

With the communication system 1 according to the present example embodiment, the use of the traffic information of the entire communication system 1, the quality information, and the topology information makes it possible to predict the traffic appropriate for the entire communication system 1 and to control the modulation scheme and the transmission power accordingly.

### Other Example Embodiments

The transmission lines illustrated in the foregoing example embodiments can be applied to a transmission line involving the link aggregation group (LAG) technique with bundled lines. In this case, the power consumption can be reduced by controlling the power supply of the transmission and reception interface of a line that is in surplus in accordance with the predicted traffic information.

According to the foregoing example embodiments, the present disclosure has been described as a configuration of hardware, but the present disclosure is not limited thereto. The monitoring device 10 according to the present disclosure includes an example embodiment in the form of a monitoring method, for example. Specifically, the monitoring method includes a step of acquiring traffic information of a plurality of transmission lines, a step of acquiring topology information of the transmission lines, and a step of predicting traffic on each of the transmission lines based on the traffic information and the topology information.

Furthermore, according to the present disclosure, the processes of the monitoring device 10 can be implemented by causing a central processing unit (CPU) to execute a program.

In the foregoing examples, the program can be stored by use of various types of non-transitory computer readable media and supplied to a computer. The non-transitory computer-readable media include various types of tangible storage media. Examples of the non-transitory computer-readable media include a magnetic recording medium (e.g., a flexible disk, a magnetic tape, a hard-disk drive), a magneto-optical recording medium (e.g., a magneto-optical disk), a CD-ROM (read-only memory), a CD-R, a CD-R/W, and a semiconductor memory (e.g., a mask ROM, a programmable ROM (PROM), an erasable PROM (EPROM), a flash ROM, a random-access memory (RAM)). The program may also be supplied to a computer by use of various types of transitory computer-readable media. Examples of such transitory computer-readable media include an electric signal, an optical signal, and an electromagnetic wave. The transitory computer-readable media can supply the program to a computer via a wired communication line, such as an electric wire or an optical fiber, or via a wireless communication line.

The above-described program is a monitoring program that causes an information processing device to execute a process of acquiring traffic information of a plurality of transmission lines, a process of acquiring topology information of the transmission lines, and a process of predicting traffic on each of the transmission lines based on the traffic information and the topology information.

As described above, the present disclosure can provide a monitoring device, a communication system, a monitoring method, and a monitoring program that predict traffic appropriate for an entire communication system and control each modulation scheme and each transmission power.

Thus far, some example embodiments of the present disclosure have been described in detail with reference to the drawings. Specific configurations, however, are not limited to those described above, and various design changes and so on can be made within the scope that does not depart from the spirit of the present disclosure.

What is claimed is:

1. A monitoring device capable of communicating with a plurality of transmission devices, the monitoring device comprising:
an acquiring unit configured to acquire traffic information of a plurality of transmission lines connecting between the plurality of transmission devices and topology information of the transmission lines; and
a predicting unit configured to predict traffic on each of the transmission lines based on the traffic information and the topology information.

2. The monitoring device according to claim 1, wherein the acquiring unit is configured to further acquire signal reception level information in each of the transmission devices, and
the predicting unit is configured to further predict the traffic based on the signal reception level information.

3. The monitoring device according to claim 1, wherein the acquiring unit is configured to acquire port ID information of the transmission devices as well as the traffic information, and
the predicting unit is configured to predict the traffic on the transmission line corresponding to the port ID information.

4. The monitoring system according to claim 1, wherein each of the transmission lines is a wireless communication line.

5. A communication system comprising:
a plurality of transmission devices; and
a monitoring device connected to and capable of communicating with the plurality of transmission devices, wherein
the monitoring device includes
an acquiring unit configured to acquire traffic information of a plurality of transmission lines connecting between the plurality of transmission devices and topology information of the transmission lines, and
a predicting unit configured to predict traffic on each of the transmission lines based on the traffic information and the topology information, and
the transmission devices each acquire predicted traffic information indicating the traffic predicted by the monitoring device.

6. The communication system according to claim 5, wherein the transmission devices each determine a modulation scheme and a transmission power of the transmission line based on the acquired predicted traffic information and signal reception level information indicating a level of a signal received by the transmission device.

7. The communication system according to claim 6, wherein the transmission devices each carry out communication based on the determined modulation scheme and the determined transmission power.

8. The communication system according to claim 5, wherein at least one of the plurality of transmission lines is bundled by a link aggregation group (LAG) technique.

9. A monitoring method comprising:
acquiring traffic information of a plurality of transmission lines connecting between a plurality of transmission devices;
acquiring topology information of the transmission lines; and
predicting traffic on each of the transmission lines based on the traffic information and the topology information.
